(19) United States
(12) Patent Application Publication
(10) Pub. No.: US 2011/0047476 A1
(43) Pub. Date: Feb. 24, 2011

(54) IMAGE-BASED REMOTE ACCESS SYSTEM

(76) Inventors: Roland M. Hochmuth, Ft. Collins, CO (US); David Andrew Thomas, Ahterton, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/933,702

(22) PCT Filed: Mar. 24, 2008
(86) PCT No.: PCT/US08/58032

§ 371 Date: Sep. 21, 2010

(51) Int. Cl. G06F 3/00

(52) U.S. Cl. 715/744; 709/203

(57) ABSTRACT

Image-based remote access systems and methods are described herein. At least some illustrative embodiments include a method that includes dividing into a plurality of sub-regions graphical data in a first frame buffer (402) associated with a graphics adapter (each of the sub-regions uniquely associated with one of a plurality of displays, and each location within the frame buffer including pixel data to be presented on a display), generating difference data (404) by comparing data in a second frame buffer (also associated with the graphics adapter and including previously presented display data) with the data in the first frame buffer, and transmitting within a message at least part of the difference data (410) across a network to a client device that includes the plurality of displays (the message including difference data associated with a sub-region (406), and a sub-region identifier). The difference data is usable to update an image on the plurality of displays.

### BACKGROUND

As wide area networks (WANs) have continued to proliferate, the client/server computing model has similarly seen an increase in its application by a wide variety of both enterprise and home users. In the client/server model, one or more server computers (generally very fast computers with large amounts of processing power and other resources such as memory and data storage space) are setup at a central location from where the servers communicate with a number of smaller and less powerful client computers across a network (e.g., the Internet). The server is configured to run software applications that are designed to be controlled by a user operating the client computer. These frequently large and complex software applications execute on the server and perform most of the computations required to accomplish the task initiated by the user, thus taking advantage of the superior processing resources of the server (as compared to those of the client).

Software executing on the client computer forwards the commands issued by the user to the software applications executing on the server. The software also receives responses and/or results from the server software applications for presentation to the user at the client computer. An example of the client/server model is a remote desktop client/server application. The server computer executes an instance of a full operating system and its associated applications, as well as a server-side remote desktop application that redirects to the client computer the display output generated by a graphics adapter within the server and under the control of the operating system instance. The client computer executes a client-side remote desktop application, which displays the output generated by the operating system running on the server computer (e.g., the desktop and windows in a windowed operating system such as Microsoft® Windows®). The client-side remote desktop application also accepts input from the user (e.g., from a keyboard and mouse), and redirects to the server computer the user inputs received at the client computer. Communication between the client and server computers takes place over a network such as, for example, the Internet.

In order to further shift the computational burden of the client to the server, and thus further reduce the complexity and cost of the client, software and hardware have been developed that shift much of the graphics processing from the client to the server. In such systems, the server processes and formats the graphical data (e.g., via a graphics processing unit (GPU) within the server) and stores the data in a frame buffer. But instead of locally presenting the frame buffer data to a user on a locally attached display unit, the frame buffer data is transmitted across a network to a thin client, desktop personal computer (PC), or network attached display device, which displays the data without the need for processing and/or formatting by a client-local GPU. See for example, U.S. Pat. App. Pub. 2005/0193396 by Stafford-Fraser et al. (hereinafter “Stafford”) and entitled “Computer Network Architecture and Method of Providing Display Data.” The graphics adapter in such a system is thus “virtualized” within the server.

While such virtualized graphics adapters serve to simplify the client hardware and software, the demands on the server hardware and software are commensurately increased. While this is to be expected in (and in fact is one of the goals of) a client/server model, the effect is multiplied when the virtualized graphics adapter of Stafford is used with clients that require multiple dis'plays. For example, if a client PC with multiple displays is replaced by a simplified client (sometimes referred to as a “thin client”) with multiple displays, and the virtualized graphics adapter of Stafford is used on the server side, multiple virtualized graphics adapters (one for each display) must be executed at the server for each client. As a result, a significant increase in the resources required at the server for each client may result from executing multiple virtualized display adapter instances, when compared to the requirements for a server that executes only a single virtualized adapter instance for each client.

### BRIEF DESCRIPTION OF THE DRAWINGS

For a detailed description of exemplary embodiments of the invention, reference will now be made to the accompanying drawings in which:

FIG. 1 shows the hardware components of a remote access client/server system, in accordance with at least some illustrative embodiments;

FIG. 2 shows the software components of the remote access client/server system of FIG. 1, in accordance with at least some illustrative embodiments;

FIG. 3A shows a computer system suitable to implement the server computer of FIG. 1, in accordance with at least some illustrative embodiments;

FIG. 3B shows a block diagram of the computer system of FIG. 3A, in accordance with at least some illustrative embodiments;

FIG. 3C shows a block diagram of computer system suitable to implement at least part of the client device of FIG. 1, in accordance with at least some illustrative embodiments; and

FIGS. 4A and 4B show methods for distributing, processing and displaying graphical data using the server computer and client device of FIGS. 1 and 2, in accordance with at least some illustrative embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Additionally, the term “system” refers to a collection of two or more hardware and/or software components, and may be used to refer to an electronic device, such as a computer, a portion of a computer, a combination of computers, etc. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

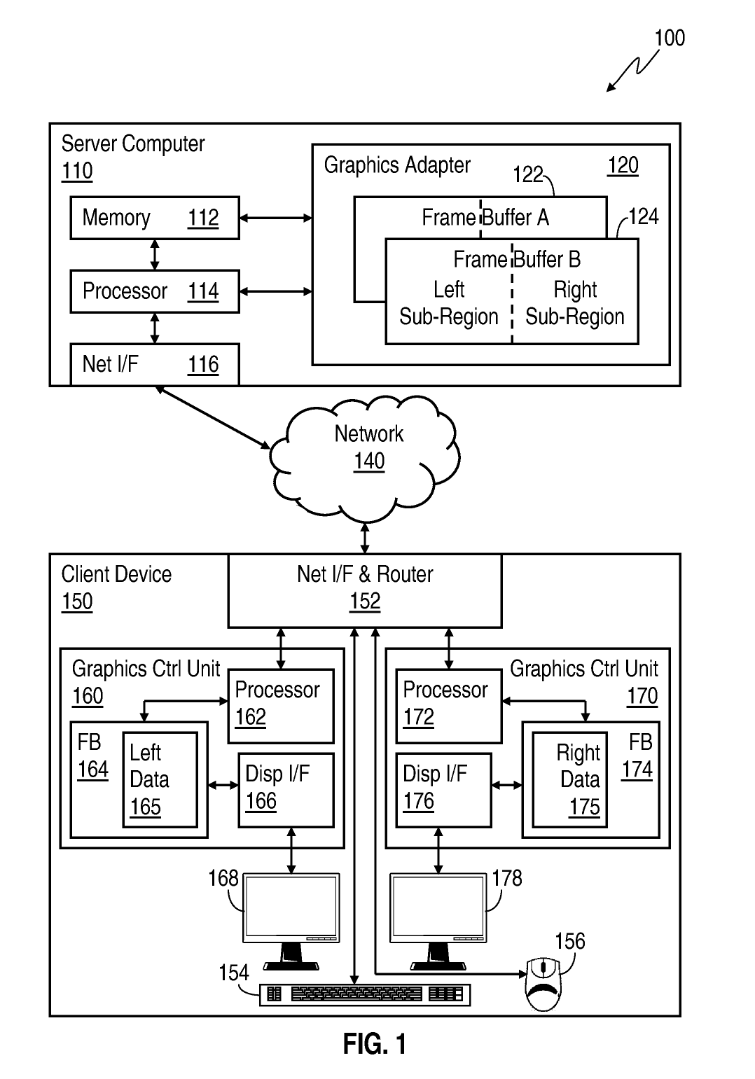

FIG. 1 shows a client/server computing system suitable for implementing an image-based remote access system, in accordance with at least some illustrative embodiments. Server computer 110 includes processor 114, which couples to memory 112, network interface (Net I/F) 116 and graphics adapter 120. Graphics adapter 120 includes multiple frame buffers (e.g., frame buffer A (122) and frame buffer B (124) used to store processed image data that is presented on a display as explained below. Graphics adapter 120 also couples to memory 112, allowing the graphics adapter to transfer data to be processed (e.g., by a graphics processing unit (GPU) with graphics adapter 120 (not shown)) from memory 112 with little or no intervention by processor 114 (e.g., via a direct memory access (DMA) transfer). In at least some illustrative embodiments, memory 112 may also include frame buffers (not shown).

Server computer 110 couples to client device 150 via network 140 (e.g., the Internet). Server computer transfers graphical image data stored in at least one of frame buffers 122 or 124 to client device 150 for presentation as a displayed image on each of client displays 168 and 178. Client device 150 includes network interface and router (Net I/F & Router) 152, which couples to each of graphics control units (Graphics Ctrl Unit) 160 and 170. Graphics control units 160 and 170 each respectively couple to display devices 168 and 178. Network interface and router 152 also couples to keyboard 154 and mouse 156. Each of the graphics control units 160 and 170 include a processor (162, 172) coupled to network interface and router 152 and a frame buffer (164, 174).

Each frame buffer includes data corresponding to data from a sub-region of a frame buffer within server computer 110. In the illustrative embodiment of FIG. 1, for example, client frame buffer 164 includes left data 165, which corresponds to the data from the left sub-region of server frame buffer 124. Similarly, client frame buffer 174 includes right data 175, which corresponds to the data from the right sub-region of server frame buffer 124. Data from within each frame buffer is read out by the corresponding display interface (166, 176), which generates the control and data signals necessary to present an image on each of displays 168 and 178 based upon the data stored in the corresponding frame buffer. The control and data signals may be digital signals, analog signals, or a combination of both digital and analog signals.

The frame buffers of both server computer 110 and client device 150 are used to store image data that has already been processed (e.g., by processor 114 or graphics adapter 120). Such processing may include converting objects such as geometric objects (e.g., lines, squares, triangles) to displayed images, and/or applying advance two- and three-dimensional transformations to complex images, such as lighting, shading, shadowing and texture mapping, just to name a few examples. The end result of such operations is a representation of the resulting image to be presented on one or more display devices. Such a representation may be stored in a frame buffer, which is a specialized memory device or region of memory that is used to store data associated with the represented image such that each location within the buffer corresponds to a pixel on the screen.

For example, in at least some illustrative embodiments a single pixel is represented by a 32-bit value (e.g., 4 bytes, each respectively representing an 8-bit intensity value for the primary colors red, green and blue and the opacity value alpha (RGBA) for the pixel). Thus, if each row of a displayed image has 2560 pixels (e.g., as part of an image measuring 2560×1024 pixels), represented by 2560 RGBA values, than 10240 data bytes are stored in the frame buffer, in sequentially addressed locations within the memory or memory region of the frame buffer, for each scan line of pixels on one or more displays. By sequentially storing the data as sequential RGBA values, the data can be read out in the order that it will be presented on the display device, simplifying the processes of extracting the data from the buffer. Further, the data for each scan line may be stored such that a single memory device row corresponds to a single scan line. Thus if a memory row is sized to the next largest binary multiple beyond the amount of data required for a scan line (16384 bytes in the example described), a single scan line may be addressed using the most significant or upper bits of the memory address, while the lower bits may be used to address the pixel data of a row or scan line.

Because of the manner in which image data is organized and stored within a frame buffer, regions within an image may be mapped directly to regions within the address space of the frame buffer that stores the image. Thus, in the illustrative embodiment of FIG. 1, which shows two regions representing a left and right side of an image to be displayed, each row of the frame buffer may be divided into pixel values store within a first address range (e.g., the first 5120 bytes, bytes 0-5120, of the row) corresponding to the left side of the image, and pixel values stored with a second address range (e.g., the second 5120 bytes, bytes 5120-10239, of the row), corresponding the right side of the image.

Pixel values for a region may be referenced relative to that region by applying one or more offset values to the region-relative pixel x-y coordinate. In the example described above, the pixel data for pixel (0, 0) of the right region (i.e., at the origin of the right region) is stored within the frame buffer at locations 5120-5123 of the first row of the buffer (i.e., pixel 1280 of row 0). The pixel data start address may be determined by adding the appropriate pixel coordinate offset to the region-relative x-coordinate of the pixel, multiplying the resulting offset pixel coordinate by the number of bytes per pixel, and adding the product of the bytes per buffer row times the y-coordinate (e.g., start byte address=4*(x+1280)+16384*y). The inverse of these calculations may also be performed to determine a region-relative pixel coordinate from the frame buffer address. Similar groupings of rows and offset calculations may also be used to define vertically divided regions of an image. Those of ordinary skill in the art will recognize that any number of vertical or horizontal regions, or both vertical and horizontal regions, may be defined within a frame buffer, and that many other coordinate-to-address and address-to-coordinate transformations may be applied to the embodiments described herein. All such numbers and combinations of regions, and all such coordinate and address transformations are within the scope of the present disclosure.

Continuing to refer to the illustrative embodiment of FIG. 1, server computer 110 includes at least two frame buffers (e.g., frame buffers 122 and 124). Each frame buffer is alternately updated with new display data in order to generate difference data, i.e., to identify data that has changed between the update of one frame buffer and the following update to the other frame buffer. For example, in at least some illustrative embodiments frame buffer 122 is initially loaded with image data during a pre-defined interval (e.g., a 16.67 milliseconds interval, corresponding to a 60 Hertz displayed frame rate). At the end of the interval, any updates to the image are redirected to frame buffer 124 (which also stores a copy of the initial image), while the initial image data within frame buffer 122 is transmitted to client device 150 for display.

At the end of the next interval, the contents of frame buffer 122 and 124 are compared (byte-for-byte) to identify those bytes of data that changed during the interval. Only those data bytes that changed during the interval (i.e., the difference data) are transmitted to the client device 150, which reduces the amount of data transmitted for images that are not changing very much from frame to frame. Once the difference data is identified, the frame buffers are again swapped, and data from frame buffer 124 is copied to frame buffer 122, so that frame buffer 122 may be updated with newer data while the difference data is extracted from frame buffer 124 for transmission to client device 150. In at least some illustrative embodiments, the entire content (for all regions) of the frame buffer that contains the newest data is periodically transmitted to client device 150 without generating difference data. These “reference frames,” as they are sometimes referred to, are transmitted in case some difference data was not received by client device 150 (e.g., if a connectionless network transaction, such as an IP datagram, was used to send the data and the message was lost due to a network disruption).

Referring still to the illustrative embodiment of FIG. 1, once the difference data has been generated, it is subdivided by sub-region and messages are sent from server computer 110 to client device 150, wherein each message includes only data for a particular sub-region. The message also includes a sub-region identifier. When a message with difference data is received by client device 150, network interface and router 152 determines which sub-region the difference data received corresponds to, based upon the sub-region identifier within the message. The difference data is then sent to the graphics control unit coupled to the display that corresponds to the identified sub-region.

In at least some illustrative embodiments the difference data may be unencapsulated from the message used to transmit the data across the network before being forwarded. In other illustrative embodiments, the entire message may be forwarded and unencapsulated from the network message by the graphics control unit receiving the difference data. In at least some illustrative embodiments, the difference data is received within a message formatted according to the transmission control protocol/Internet protocol (TCP/IP) network protocol, and transferred to the appropriate graphics control unit using individual universal serial bus (USB) communication links between network interface and router 152, and each of the graphics control units. Keyboard 154 and mouse 156 also couple to network interface and router 152, as shown in FIG. 1, via individual USB links.

Continuing to refer to FIG. 1, the processors of each of the graphics control units (processor 162 of graphics control unit 160, and processor 172 of graphics control unit 170) receive the difference data corresponding to the display coupled to the respective graphics control unit (display 168 or display 178), and update their respective client frame buffers with the appropriate data. Thus, difference data received from computer server 110 corresponding to the left sub-region of a frame buffer is routed by network interface and router 152 to processor 162, which uses the difference data to update left data 165 within frame buffer 164. The data is then used by display interface 166 to update the image presented on display device 168. A similar operation is performed by graphics control unit 170, processor 172 and display interface 176 for right sub-region frame buffer data from server computer 110 that results in right data being update within frame buffer 174 and presented on display device 178.

As is evidenced by the description above, the operations performed at the client device require less graphical computational power than that required by server computer 110. This is due to the fact that the computationally intensive graphics processing operations are performed by graphics adapter 120, which then transfers to client device data requiring much less processing, even in embodiments that compress and decompress the image data sent to client device 150. This results in what is sometimes referred to as a “thin” client, both in terms of the hardware and the software that implements the functionality of client device 150. The use of frame buffer data between computer server 110 and client device 150, instead of data that requires extensive graphics processing (e.g., geometric object data), results in an image-based remote access system that operates using thin clients that are easily and inexpensively scaled.

In at least some illustrative embodiments, the image data transmitted from server computer 110 to client device 150 (including difference data, reference frames, or both) is compressed prior to being transmitted to further reduce the bandwidth required to transfer the image data. In at least some illustrative embodiments the compression is performed by processor 114, while in other illustrative embodiments the compression is performed by graphics adapter 120. Decompression is performed by processors 162 and 172 of client device 150, each processor decompressing the received data corresponding their respective sub-regions and displays. The compression/decompression may be implemented using any of a number of known compression/decompression (CODEC) algorithms, may include both lossy and lossless compression/decompression techniques, and may include both hardware and software implementations, as well as combinations of hardware and software implementations. All such CODEC algorithms, techniques and implementations are within the scope of the present disclosure.

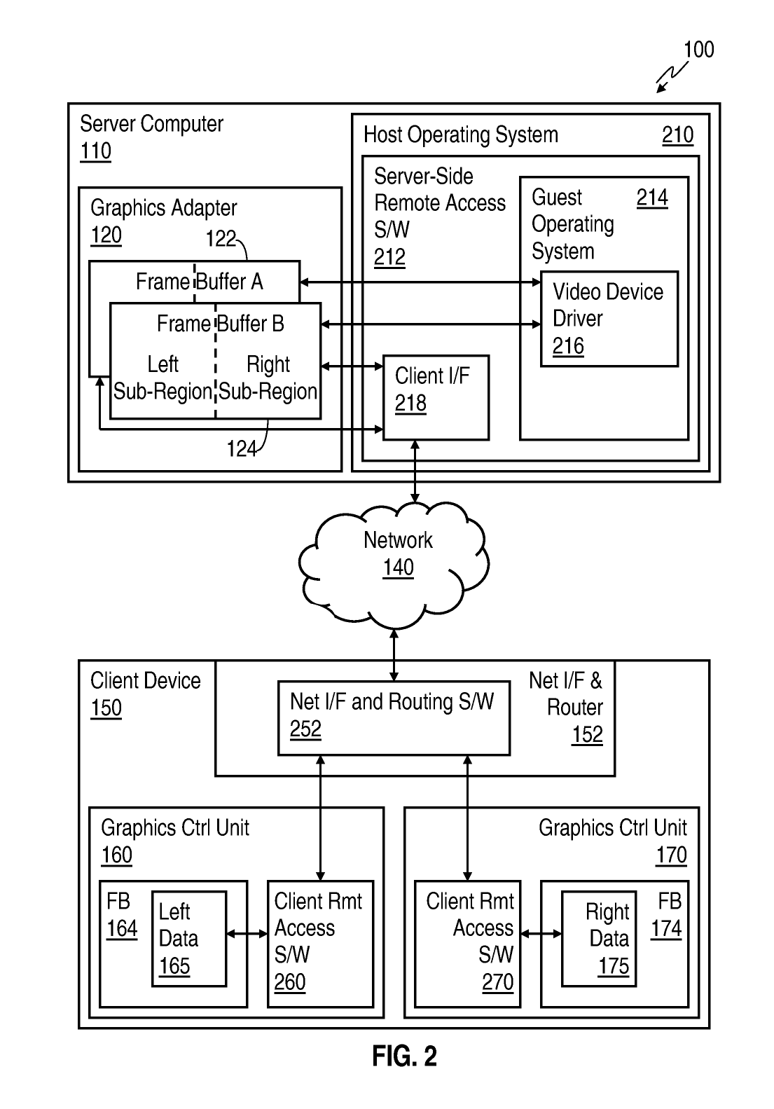

FIG. 2 shows a block diagram of the software components that implement at least some of the functionality of the system and methods described herein, in accordance with at least some illustrative embodiments. Host operating system 210 executes on server computer 110 and provides the operating environment under which server-side remote access software 212 executes. Guest operating system 214 executes within the environment provided by server-side remote access software 212 that exposes graphics adapter 120 to the video device driver 216 executing under guest operating system 214.

In at least some illustrative embodiments (not shown) two or more guest operating systems concurrently execute under server-side remote access software 212, which arbitrates access to graphics adapter 120. As a result of such arbitration, graphics adapter 120 is exposed to each guest operating system as a dedicated resource, even though it is actually shared between the guest operating systems. The graphics adapter, which in at least some illustrative embodiments is not used by server computer 110 to locally drive a display device, thus operates as an “offload” graphics processor that is managed by server-side remote access software 212 as a shared resource. In other illustrative embodiments, a virtualized graphics adapter is implemented for each guest operating system instance by server-side remote access software 212.

Continuing to refer to FIG. 2, once the data within a frame buffer has been updated, client interface software (Client I/F) 218 (part of server-side remotes access software 212) generates the difference data (as well as any reference frames) as previously described, divides the image data (difference and/or reference frame data) by sub-region, and generates messages (with the appropriate corresponding sub-region identifiers) to be transmitted to client device 150. In at least some embodiments wherein image data compression is performed by server processor 114 of FIG. 1, the image data (difference and/or reference frame data) is compressed by client interface software 218.

In at least some illustrative embodiments the image data transmitted by client interface software 218 is received and processed by network interface and routing software 252, executing on network interface and router 152 (e.g., on a processor within network interface and router 152 (not shown)). Client interface software 252 implements a network protocol stack (e.g., a TCP/IP protocol stack), wherein client device 150 is accessed as a network addressable TCP/IP device. Client routing software 252 converts the received image data messages to a format suitable for transmission to the graphics control units (e.g., USB transactions), and routes the image data to the appropriate graphics control unit based on the sub-region identifier within the received message. Client remote access software 260 and 270, executing on client processors 162 and 172 respectively, extract (and if necessary decompress) the received image data, and update the corresponding client frame buffer (164 or 174).

In the illustrative embodiments described, software executing on the various processors present in both the server computer 110 and client device 150 perform many of the functions described herein. Nonetheless, those of ordinary skill in the art will recognize that other illustrative embodiments may implement at least some of the functionality described in software or hardware (e.g., using application specific integrated circuits (ASICs)), or by a combination of software and hardware, and all such embodiments are within the scope of the present disclosure.

In at least some illustrative embodiments, network interface and router software 252, in conjunction with client interface software 218, operate to provide a configuration interface to a user of the remote access system described herein. The configuration interface allows a user to specify the layout, relative positions and resolution of the display devices (168 and 178 of FIG. 1) that are coupled to each graphics control unit of client device 150. For example, if two displays are organized left to right with a resolution of 1280×1024 for each display device, the configuration interface would allow the configuration to be specified using the client device. The configuration information (i.e., the display resolution, number of display devices, and relative positions of the display devices) would be sent to the Server and used to configure the sub-regions respectively. In the example described and shown in FIGS. 1 and 2, the Server would have a single virtual display resolution of 2560×1024 comprised of two sub-regions of 1280×1024 each, and with origin locations of (0, 0) and (1280, 0) respectively.

Because the guest operating system 214 of the example in FIG. 2 is configured to recognize only a single graphics adapter, changes to the number of displays and the resolution of each individual display may be done independently of the configuration of the graphics adapter as seen by the guest operating system 214. In other illustrative embodiments, changes to the configuration of the graphics adapter at the guest operating system level (e.g., by changing the screen resolution through utilities provided by the guest operating system) may be linked by the client interface software 218 to changes in the sub-region and display configuration at both server computer 110 and client device 150. Other configurations and combinations of operating system based and remote access software based configuration utilities will become apparent to those of ordinary skill in the art, and all such configurations and combinations are within the scope of the present disclosure.

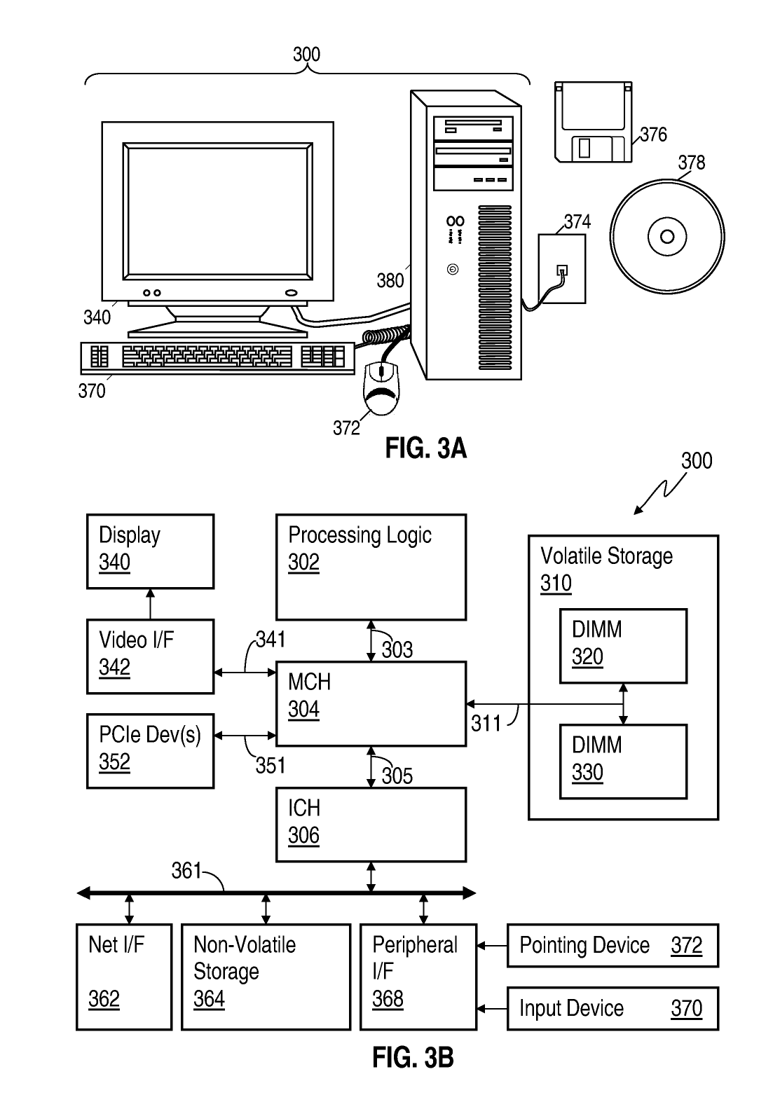

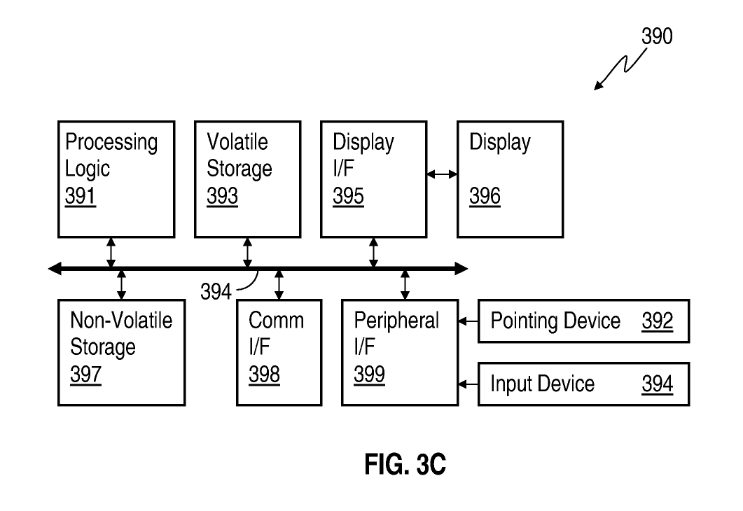

FIGS. 3A and 3B show an illustrative computer system 300 suitable for implementing server computer 110 of FIG. 1. FIG. 3C similarly shows a simplified computer system 390 (simplified relative to the system of FIG. 3B), suitable for implementing both network interface and router 152 and at least part of each of graphic control units 160 and 170. As shown in FIGS. 3A and 3B, the illustrative computer system 300 includes a chassis 380, a display 340, and an input device 370. The computer system 300 includes processing logic 302, volatile storage 310, and non-volatile storage 364. The computer system 390 of FIG. 3C similarly includes processing logic 391, volatile storage 393, and non-volatile storage 397. Continuing to refer to FIGS. 3A, 3B and 3C, processing logic 302 and processing logic 391 may both be implemented in hardware (e.g., a microprocessor), software (e.g., microcode), or a combination of hardware and software. Computer systems 300 and 391 also include a computer-readable medium. The computer-readable medium may include volatile storage 310 and 393 (e.g., random access memory (RAM)), non-volatile storage 364 and 397 (e.g., flash RAM, read-only memory (ROM), a hard disk drive, a floppy disk (e.g., floppy 376), a compact disk read-only memory (CD-ROM, e.g., CD 378)), or combinations thereof.

Either or all of volatile storage 310, volatile storage 393, non-volatile storage 364 and non-volatile storage 397 include, for example, software that is executed by processing logic 302 or 391, respectively, and provides the computer systems 300 and 390 with some or all of the functionality described herein. The computer system 300 also includes a network interface (Net I/F) 362 that enables the computer system 300 to receive information via a local area network and/or a wired or wireless wide area network, represented in the example of FIG. 3A by Ethernet jack 392. Computer system 390 includes communication interface (Comm I/F) 398, which performs a function similar to that of network interface 362. A video interface (Video I/F) 342 couples to the display 340 in computer system 300. A display interface (display I/F) 395 couples to display 396 in at least some illustrative embodiments of computer system 390 used to implement graphics control units 160 and 170 (not present in at least some illustrative embodiments of computer system 390 used to implement network interface and router 152). When locally operating computer system 300, a user interacts with the system via the input device 370 (e.g., a keyboard) and/or pointing device 372 (e.g., a mouse), which couple to a peripheral interface 368. When operating computer system 390 (e.g., when used to implement network interface and router 152), a user similarly interacts with the system via input device 394 and pointing device 392, which coupled to peripheral interface 399 (none of which are present in at least some illustrative embodiments of computer system 390 used to implement graphics control units 160 and 170). The display 340, together with the input device 370 and/or the pointing device 372, of computer system 300 (and similarly the displays 168 and 178, input device 394 and pointing device 392 of computer system 390) may operate together as a user interface.

Computer system 300 may be a bus-based computer, with a variety of busses interconnecting the various elements shown in FIG. 3B through a series of hubs or bridges, including memory controller hub (MCH) 304 (sometimes referred to as a “north bridge”) and interface controller hub (ICH) 306 (sometimes referred to as a “south bridge”). The busses of the illustrative example of FIG. 3B include: front-side bus 303 coupling processing logic 302 to MCH 304; accelerated graphics port (AGP) bus 341 coupling video interface 342 to MCH 304; peripheral component interconnect (PCI) bus 361 coupling network interface 362, non-volatile storage 364, peripheral interface 368 and ICH 306 to each other; PCI express (PCIe) bus 351 coupling one or more PCI express devices 352 to MCH 304; and memory bus 311 coupling MCH 304 to dual inline memory modules (DIMMs) 320 and 330 within volatile storage 310.

Computer system 390 may also be a bus-based computer, with PCI bus 394 coupling the various elements shown in FIG. 3C to each other, including processor 391, volatile storage 393, display interface 395, non-volatile storage 397, communication interface 398 and peripheral interface 399.

The peripheral interface 368 of computer system 300 accepts signals from the input device 370 and other input devices such as a pointing device 372, and transforms the signals into a form suitable for communication on PCI bus 361. The peripheral interface 399 of computer system 390 similarly accepts signals from the input device 394 and other input devices such as a pointing device 392, and transforms the signals into a form suitable for communication on PCI bus 394. The display interface 342 of computer system 300 may include a graphics card or other suitable video interface that accepts information from the AGP bus 341 and transforms it into a form suitable for the display 340. The display interface 395 of computer system 390 may include video control logic that accepts frame buffer data from PCI bus 394 and transforms it into a form suitable for the display 396.

The processing logic 302 of computer system 300 gathers information from other system elements, including input data from the peripheral interface 368, and program instructions and other data from non-volatile storage 364 or volatile storage 310, or from other systems (e.g., a server used to store and distribute copies of executable code) coupled to a local area network or a wide area network via the network interface 362. The processing logic 302 executes the program instructions (e.g., server remote access software 212) and processes the data accordingly. The program instructions may further configure the processing logic 302 to send data to other system elements, such as information presented to the user via the video interface 342 and the display 340. The network interface 362 enables the processing logic 302 to communicate with other systems via a network (e.g., the Internet). Volatile storage 310 may serve as a low-latency temporary store of information for the processing logic 302, and non-volatile storage 364 may serve as a long term (but higher latency) store of information.

The processing logic 391 of computer system 390 similarly gathers information from other system elements, including input data from the peripheral interface 399, and program instructions and other data from non-volatile storage 397 or volatile storage 393, or from other external systems (e.g., a server used to store and distribute copies of executable code) accessible by computer system 390 via the communication interface 399. The processing logic 391 executes the program instructions (e.g., client remote access software 260 and 270) and processes the data accordingly. The program instructions may further configure the processing logic 391 to send data to other system elements, such as information presented to the user via the display interface 395 and the display 396. The communication interface 398 enables the processing logic 391 to communicate with other systems. Volatile storage 393 may serve as a low-latency temporary store of information for the processing logic 391, and non-volatile storage 397 may serve as a long term (but higher latency) store of information.

The processing logic 302, and hence the computer system 300 as a whole, operates in accordance with one or more programs stored on non-volatile storage 364 or received via the network interface 362. The processing logic 302 may copy portions of the programs into volatile storage 310 for faster access, and may switch between programs or carry out additional programs in response to user actuation of the input device 370. The additional programs may be retrieved from non-volatile storage 364 or may be retrieved or received from other locations via the network interface 362. One or more of these programs executes on computer system 300, causing the computer system to perform at least some functions disclosed herein.

Likewise, the processing logic 391, and hence the computer system 390 as a whole, operates in accordance with one or more programs stored on non-volatile storage 397 or received via the communication interface 398. The processing logic 391 may copy portions of the programs into volatile storage 393 for faster access, and may switch between programs or carry out additional programs in response to user actuation of the input device 394. The additional programs may be retrieved from non-volatile storage 397 or may be retrieved or received from other locations via the communication interface 398. One or more of these programs executes on computer system 390, causing the computer system to perform at least some functions disclosed herein.

Although the illustrative embodiments described herein, utilize 2 displays as part of client device 150, those of ordinary skill in the art will recognize that other illustrative embodiments may include any number of displays, organized in a wide variety of configurations. Examples may include 2 displays organized as a top and bottom half of an overall display, or a 4 by 3 matrix of displays, just to name a few. All such configurations and numbers of displays are within the scope of the present disclosure.

Because of the simplified design of the components of client device 150, it is possible to reduce the overall size and profile of the client device. For example, in at least some illustrative embodiments, a graphics control unit may be reduced down to a housing similar to a USB memory stick (sometimes referred to as a “dongle”) that couples to a display with a VGA connector, and to the network interface and router with a USB connector. In other illustrative embodiments, the graphics control unit may be integrated within the display device housing, with a USB cable coupling the network interface and router to each combined graphics control unit/display device. Other housing configurations will become apparent to those of ordinary skill in the art, and all such configurations are within the scope of the present disclosure.

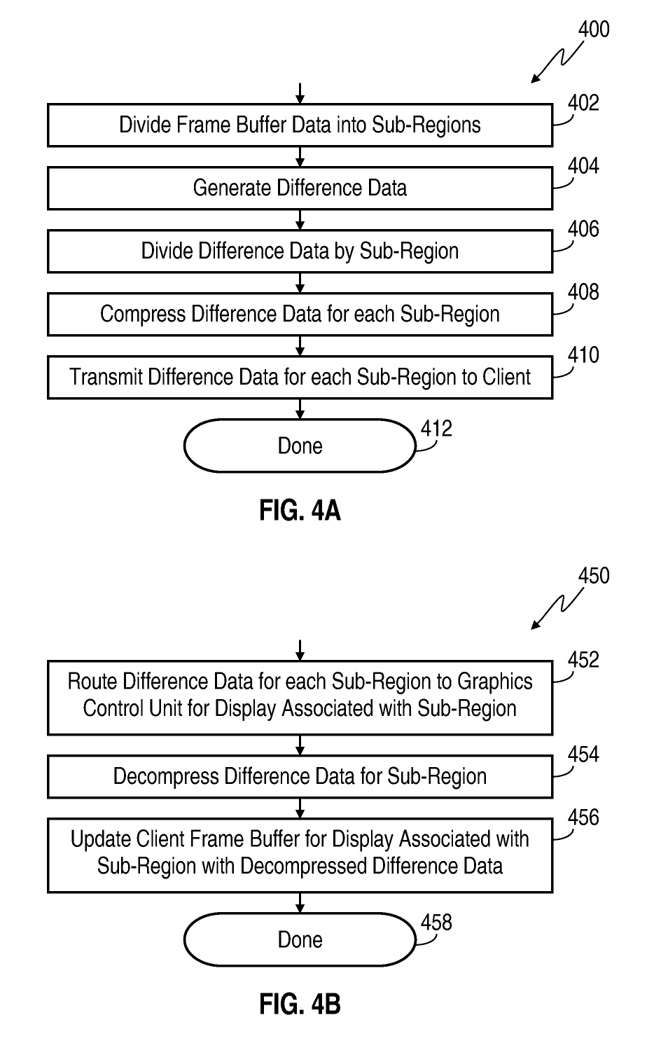

FIG. 4A shows a method 400 for generating and distributing graphical image data within a server of an image-based remote access system, in accordance with at least some illustrative embodiments. After image data within a server frame buffer is divided into sub-regions (block 402), difference data is generated by comparing a frame buffer that includes current image data, with another frame buffer that includes older frame data (block 404). The difference data is divided based upon the frame buffer sub-region that contains the data (block 406), and the data for each region is compressed (block 408). In at least some illustrative embodiments, the compression of block 408 is omitted. Once the data is compressed, messages are formed wherein each message includes difference data corresponding to a single sub-region, and that further includes a corresponding sub-regions identifier, and the messages with the difference data are transmitted to a client device (block 410), ending the method (block 412). In at least some illustrative embodiments, sub-region specific reference frames are also transmitted to client, in addition to difference data.

FIG. 4B shows a method 450 for receiving and routing graphical image data within a client of an image-based remote access system, in accordance with at least some illustrative embodiments. Upon receiving graphical image data associated with a sub-region within a server frame buffer, the image data is routed to a graphics control unit that is coupled to a display associated with the same sub-region (block 452). In at least some illustrative embodiments the graphical image data received includes difference data generated as described by method 400, while in other illustrative embodiments the graphical image data received may also include reference frame data. Once the graphical image data is routed to a graphics control unit, the data is decompressed (block 454). In at least some illustrative embodiments the decompression of block 454 is omitted. After decompression, the graphical image data is used to update the client frame buffer corresponding to the display associated with the sub-region of the data (block 456), ending the method (block 458).

The above discussion is meant to be illustrative of the principles and various embodiments of the present invention. Numerous variations and modifications will become apparent to those skilled in the art once the above disclosure is fully appreciated. For example, although the illustrative embodiments describe performing communication between the network interface and router and other client components using a USB interface, other illustrative embodiments include other suitable communication interfaces, and all such communication interfaces are within the scope of the present disclosure. Further, although the server computer was described as using double buffered frame buffers, and the client device was described as using single buffered frame buffers, any number of additional frame buffers may be used within both the server computer and client device described, and all such frame buffer configurations are within the scope of the present disclosure. Additionally, although only difference data may have been described in some illustrative embodiments, the systems and methods described also apply to the additional distribution of reference frames and reference frame data, over an above the difference data generated and distributed as described herein. Further, although the embodiments described herein included a host operating system, other illustrative embodiments include server remote access software that does not require a host operating system, or that include server remote access software that executes as a service of either a guest or a host operating system. Also, although guest operating systems configured with a single graphics adapter are shown in the illustrative embodiments described, other illustrative embodiments may include guest operating system configured with multiple graphics adapters (real or virtual), each configured with multiple sub-regions and display devices as described herein. It is intended that the following claims be interpreted to embrace all such variations and modifications.

What is claimed is:

1. A method, comprising:
dividing into a plurality of sub-regions graphical data stored in a first frame buffer associated with a graphics adapter, each of the plurality of sub-regions uniquely associated with one of a plurality of displays, and each location within the frame buffer comprising data associated with a pixel to be presented on a display;
generating difference data by comparing data stored in a second frame buffer, also associated with the graphics adapter and comprising data previously presented on the plurality of displays, with the data stored in the first frame buffer; and
transmitting within a message at least part of the difference data across a network to a client device comprising the plurality of displays, the message comprising difference data associated with a sub-region, and further comprising an identifier associated with the sub-region;
wherein the difference data is usable to update an image presented on the plurality of displays.

2. The method of claim 1, further comprising compressing the difference data before the transmitting.

3. The method of claim 2, further comprising decompressing the difference data at the client workstation after the transmitting.

4. The method of claim 1, further comprising:
receiving the message at the client device;
routing difference data within the message to a display of the plurality of displays based upon the identifier within the message; and
updating the image presented on the display using the difference data within the message.

5. The method of claim 1, further comprising operating the client device to configure the resolution of an image generated by the graphics adapter.

6. The method of claim 1, further comprising operating the client device to define the plurality of sub-regions within the first frame buffer, to associate identifiers with each of the plurality of sub-regions, and to uniquely associate each of the plurality of sub-regions with one of the plurality of displays.

7. A system, comprising:
a server computer, comprising:
server processing logic;
server memory coupled to the server processing logic; and
a graphics adapter, coupled to the server processing logic and the server memory, comprising a plurality of server frame buffers, each location within each of the plurality of server frame buffers comprising data associated with a pixel to be presented on a display;
wherein data stored with a first server frame buffer is grouped into sub-regions within the first server frame buffer, each sub-region uniquely associated with one display device of a plurality of display devices; and
wherein difference data, used to update an image presented on at least one of the plurality of display devices, is generated by determining the difference between data store in the first server frame buffer and data store in a second server frame buffer, the data in the second server frame buffer having already been previously displayed.

8. The system of claim 7, wherein the difference data is generated by either the server processing logic or the graphics adapter.

9. The system of claim 7, wherein the graphics adapter is a real graphics adapter comprising graphics processing logic, and further comprising graphics memory comprising the plurality of frame buffers.

10. The system of claim 7, wherein the graphics adapter is a virtual graphics adapter and the server memory comprises the plurality of frame buffers.

11. The system of claim 7, further comprising a server network interface coupled to the server processing logic, wherein a message, comprising difference data associated with a sub-region of the plurality of sub-regions, is transmitted by the network interface across a network to a client device, the message further comprising an identifier associated with the sub-region.

12. The system of claim 11, wherein the difference data is compressed by the sever processing logic before being transmitted to the client device.

13. The system of claim 11, wherein the client device comprises:
a client network interface and router;
a plurality of graphics control units, coupled to the client network interface and router, that each generates video control and data signals; and
the plurality of display devices each coupled to a graphics control unit of the plurality of graphics control units;
wherein the client network interface and router receives the message from the server computer and routes the message to one of the plurality of graphics control units based upon the identifier within the message; and
wherein the graphics control unit uses the difference data within the message to update the image presented on a display device of the plurality of display devices that is coupled to the graphics control unit.

14. The system of claim 13, wherein each of the plurality of graphics control units decompresses the difference data within the message received from the client network interface and router, if the difference data was previously compressed by the server computer.

15. The system of claim 13, further comprising:
a mouse coupled to the client network interface and router;
a keyboard coupled to the client network interface and router;
wherein data from the keyboard and mouse is received by the client network interface and transmitted across the network to the server computer.

16. A computer-readable medium, comprising software that causes a first processor to:
divide into a plurality of sub-regions graphical data stored in a first frame buffer associated with a graphics adapter, each of the plurality of sub-regions uniquely associated with one of a plurality of displays, and each location within the frame buffer comprising data associated with a pixel to be presented on a display;
generate difference data by comparing data stored in a second frame buffer, also associated with the graphics adapter and comprising data previously presented on the plurality of displays, with the data stored in the first frame buffer; and
transmit within a message at least part of the difference data across a network to a client device comprising the plurality of displays, the message comprising difference data associated with a sub-region, and further comprising an identifier associated with the sub-region;
wherein the difference data is usable to update an image presented on the plurality of display.

17. The computer-readable medium of claim 16, wherein the software further causes the first processor to compress the difference data before transmission.

18. The computer-readable medium of claim 17, wherein the software causes a second processor to decompress the difference data at the client workstation after transmission.

19. The computer-readable medium of claim 16, wherein the software causes a second processor to update the image presented on a display of the plurality of displays using the difference data within the message.

20. The computer-readable medium of claim 19, wherein the software causes a third processor to receive the message at the client device, and to route the difference data within the message, based upon the identifier within the message, to a graphics control unit associated with the display.
